(19) United States
(12) Patent Application Publication
(10) Pub. No.: US 2011/0234424 A1
(43) Pub. Date: Sep. 29, 2011

(54) LED WATER-PROOFING DIFFUSER EMBEDDED INTO A SHELL PLATE

(75) Inventor: Yi-Qun CHEN, Taichung City (TW)

(73) Assignee: SAFETY TRAFFIC EQUIPMENT CO., LTD., Taichung City (TW)

(21) Appl. No.: 12/731,648

(22) Filed: Mar. 25, 2010

(51) Int. Cl. G08G 1/095; F21V 3/00; G09F 13/00

(52) U.S. Cl. 340/907; 362/311.02; 40/541

(57) ABSTRACT

An LED water-proofing diffuser embedded into the shell plate, said LED water-proofing diffuser includes an LED baseplate retaining shell, which is a 3D holding space formed by an end wall and a circumferential flange. An LED assembly port is formed at the other end of the circumferential flange. An LED diffusing portion has a hollow shape protruding from the end wall of the LED baseplate retaining shell. The LED diffusing portion is available with light transmittance. An embedded positioning portion is integrally formed onto the exterior of the end wall or circumferential flange of the LED baseplate retaining shell. Said embedded positioning portion can be embedded securely into the hole of existing shell plate. Said LED water-proofing diffuser can be assembled with a single or several LED units, and waterproofing is made possible within the space of the LED water-proofing diffuser.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an LED fitting, and more particularly to an innovative one which can be assembled with an LED unit.

2. Description of Related Art Including Information Disclosed Under 37 CFR 1.97 and 37 CFR 1.98.

At present, LED has been widely applied to many light-emitting products such as: common lamps, projectors, traffic lights, traffic marking panels, advertisement lamp boxes, decorative lights and car lights, in lieu of conventional luminous bodies.

Despite of the outstanding performance of LED, there are a lot of technical problems to be addressed, for example, LEDs must be arranged at interval and also linked by electrical wire or circuit board to show the light-emitting effect. However, every linking position is vulnerable to water ingress or moisture in the operating environment of the products. In such cases, the electrical wire or circuit board of LED is possibly burnt due to short circuit. Hence, water-proofing packaging of electric structures is a crucial technology issue when the operational safety and service life of LED products are considered.

The water-proofing conventional LED products are structurally configured in such a way that the electrical wire or circuit board is poured and covered with water-proof adhesive. Such water-proofing structure can meet the water-proofing requirements, but a huge amount of water-proof adhesive has to be utilized, leading to higher fabrication cost and longer fabrication time against the customers. Moreover, such a water-proofing structure brings about time-consuming and difficult replacement in the event of LED damage.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The enhanced efficacy of the present invention is as follows:

Based on the unique structural configuration of the present invention that “the LED water-proofing diffuser embedded into shell plate” comprises: an LED baseplate retaining shell, an LED diffusing portion and embedded positioning portion. Said LED water-proofing diffuser can be assembled with a single or a few LED units. Waterproofing is made possible within the space of the LED water-proofing diffuser, thus reducing significantly the fabrication cost of the LED water-proofing structure and realizing excellent waterproofing effect as well as better convenience of replacement or maintenance and higher industrial benefits.

The improvements brought about by this invention are as follow:

Based on the structural configuration wherein a protruding rib flange is formed internally onto the end wall of the LED baseplate retaining shell, the protruding rib flange can limit the assembly depth of the LED substrate. Meanwhile, a spacing can be formed between the LED substrate and end wall of the LED baseplate retaining shell, thereby achieving appropriate heat-sink cooling effect to extend the service life of LED unit.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the present invention for the assembly relation of the LED water-proofing diffuser and LED unit.

FIG. 2 shows an exploded cross sectional view of the present invention for the assembly relation of the LED water-proofing diffuser and LED unit (note: without sectioning of LED unit).

FIG. 3 shows a perspective view of the present invention that the LED water-proofing diffuser is embedded into the shell plate (note: partial sectioning of shell plate).

FIG. 4 shows a cross sectional view of the present invention that the LED water-proofing diffuser is embedded into the shell plate.

FIG. 5 shows a schematic view of the present invention wherein the LED water-proofing diffuser is applied to traffic marking panel.

FIG. 6 shows a schematic view of the present invention wherein the LED water-proofing diffuser is applied to advertisement.

FIG. 7 shows a schematic view of the present invention wherein the LED water-proofing diffuser is applied to platy ornament.

FIG. 8 shows a cross sectional view of another preferred embodiment of the embedded positioning portion of the present invention.

### DETAILED DESCRIPTION OF THE INVENTION

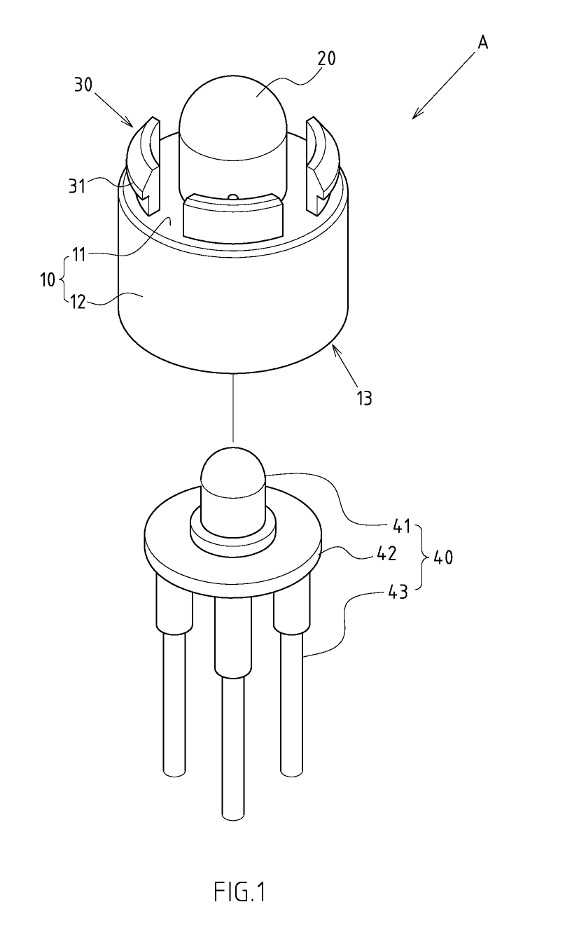

FIGS. 1-4 depict preferred embodiments of an LED water-proofing diffuser of the present invention embedded into shell plate which are provided for only explanatory objective for patent claims. Said LED water-proofing diffuser A includes an LED baseplate retaining shell 10, which is a 3D holding space formed by an end wall 11 and a circumferential flange 12. An LED assembly port 13 is formed at the other end of the circumferential flange 12.

An LED diffusing portion 20, which is of a hollow shape, protrudes from the end wall 11 of the LED baseplate retaining shell 10. The LED diffusing portion 20 must be available with light transmittance.

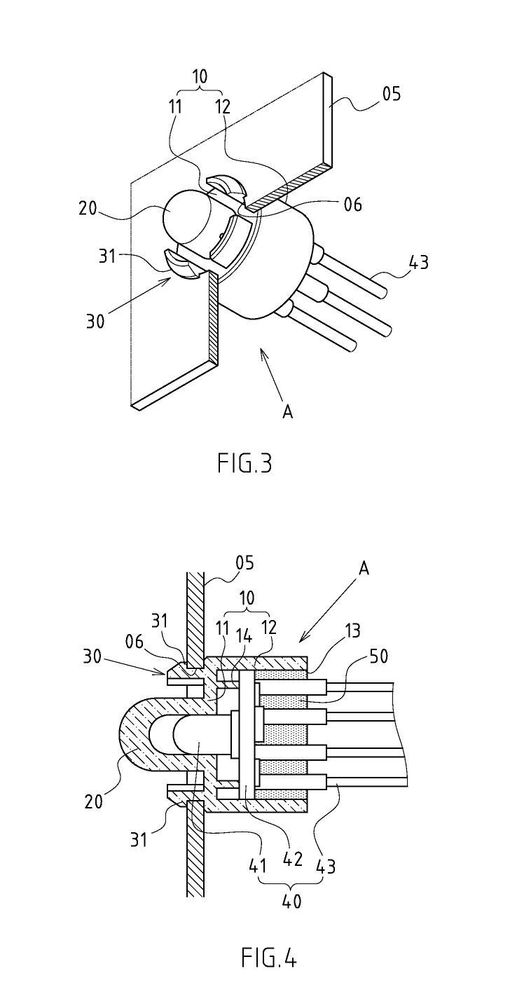

An embedded positioning portion 30 is integrally formed onto the exterior of the end wall 11 or circumferential flange 12 of the LED baseplate retaining shell 10. Said embedded positioning portion 30 can be embedded securely into the hole 06 of existing shell plate 05 (shown in FIGS. 3, 4). The embedded positioning portion 30 of the preferred embodiment comprises of several hooks 31 arranged at interval.

Of which, the LED diffusing portion 20 is protruded from the center of the end wall 11 of the LED baseplate retaining shell 10.

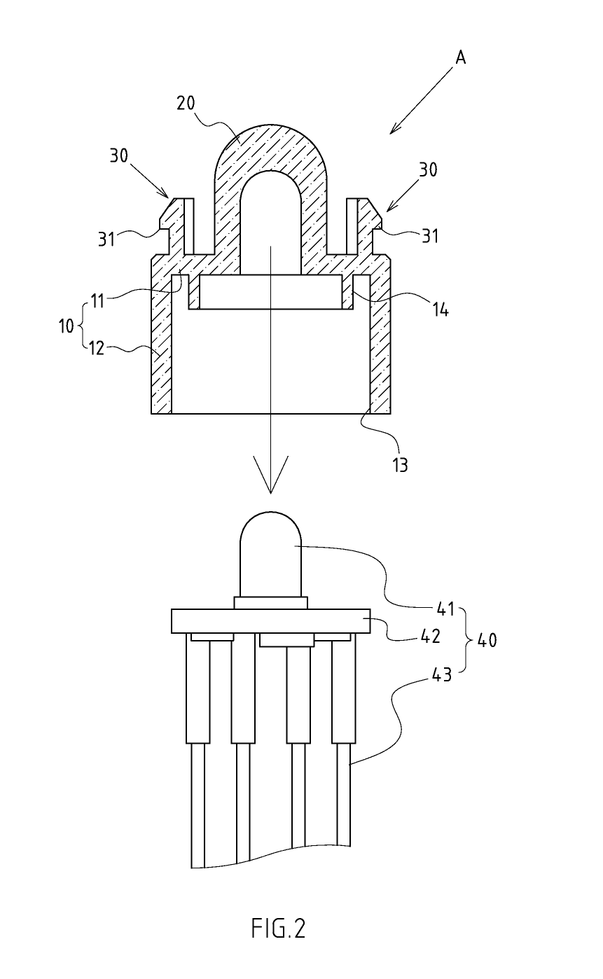

Referring to FIGS. 2, 3, 4, the LED water-proofing diffuser A is assembled externally onto an LED unit 40, which comprises at least an LED module 41, an LED substrate 42 and electrical wire 43. The LED baseplate retaining shell 10 of LED water-proofing diffuser A is used for accommodating the LED substrate 42 of LED unit 40, and the LED diffusing portion 20 is used for accommodating the LED module 41 of LED unit 40. Moreover, waterproof agent 50 is poured into the LED baseplate retaining shell 10 to seal the LED substrate 42.

Based upon above-specified structural configuration, said LED unit 40 permits protection of the exposed LED module 41 against moisture by assembly of the LED water-proofing diffuser A. Besides, the LED substrate 42 and the electrical connecting position of LED substrate 42 and electrical wire 43 can also be protected against moisture by accommodation of the LED baseplate retaining shell 10 and sealing of waterproof agent 50.

Referring to FIG. 4, a protruding rib flange 14 is formed internally onto the end wall 11 of the LED baseplate retaining shell 10. The protruding rib flange 14 can limit the assembly depth of the LED substrate 42. Meanwhile, a spacing can be formed between the LED substrate 42 and end wall 11 of the LED baseplate retaining shell 10, thereby achieving appropriate heat-sink cooling effect to extend the service life of LED unit 40.

Said LED water-proofing diffuser A is operated as follows:

Referring to FIG. 5, said LED water-proofing diffuser A is applied to a traffic marking panel 60. The traffic marking panel 60 comprises of a main body 61, an LED unit 40 set on the marking surface 62 of the main body 61, and an LED water-proofing diffuser A assembled externally on to said LED unit 40. Of which, the main body 61 is provided with a hole 63 for assembly/positioning of the LED unit 40 and embedding of the LED water-proofing diffuser A. The structural details and configurations of the LED water-proofing diffuser A and LED unit 40 are disclosed in FIGS. 3 and 4.

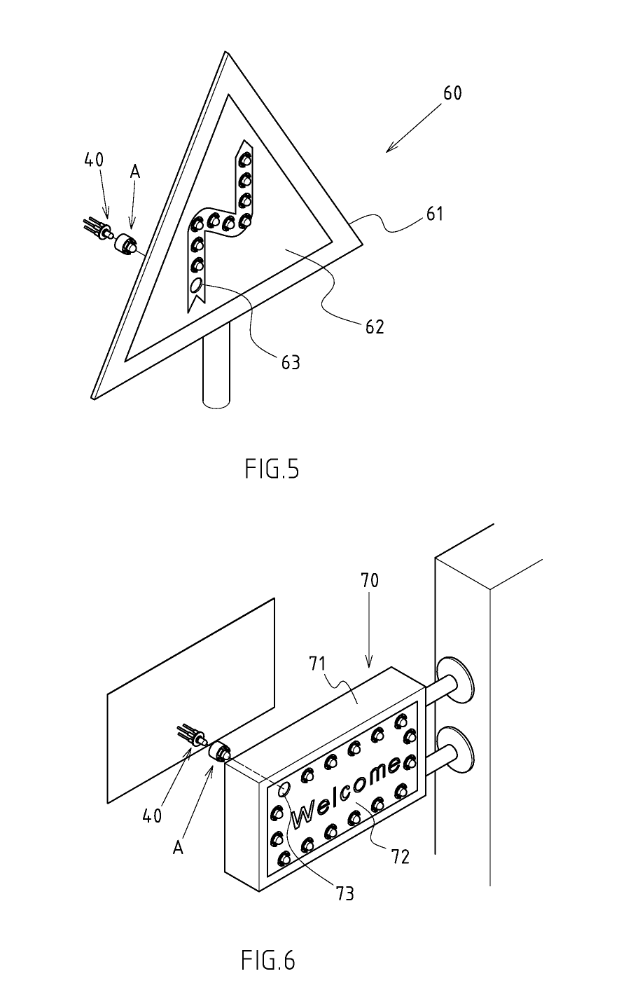

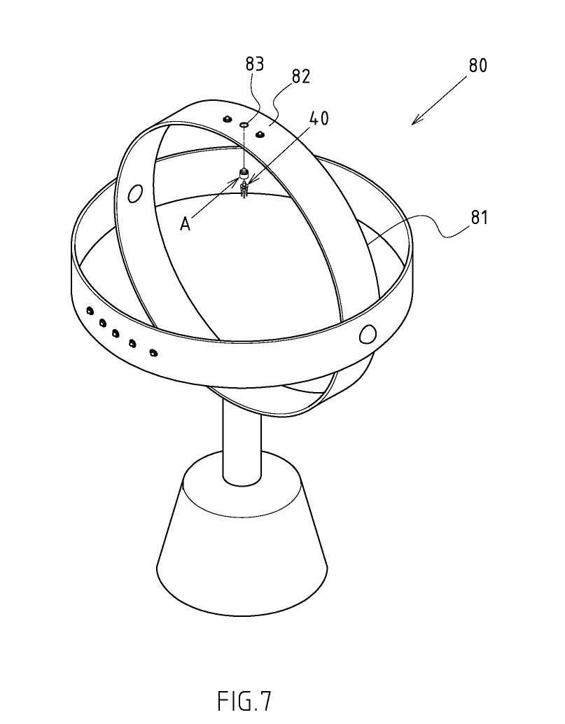

Referring also to FIG. 6, said LED water-proofing diffuser A is applied to an advertisement 70. The advertisement 70 comprises of a main body 71, an LED unit 40 set on the advertisement surface 72 of the main body 71, and an LED water-proofing diffuser A assembled externally on to said LED unit 40. Of which, the advertisement surface 72 of the main body 71 is provided with a hole 73 for embedding of the LED water-proofing diffuser A and positioning of the LED unit 40.

Referring also to FIG. 7, said LED water-proofing diffuser A is applied to a platy ornament 80. The platy ornament 80 comprises of a main body 81, an LED unit 40 set on the platy surface 82 of the main body 81, and an LED water-proofing diffuser A assembled externally on to said LED unit 40. Of which, the platy surface 82 of the main body 81 is provided with a hole 83 for embedding of the LED water-proofing diffuser A and positioning of the LED unit 40.

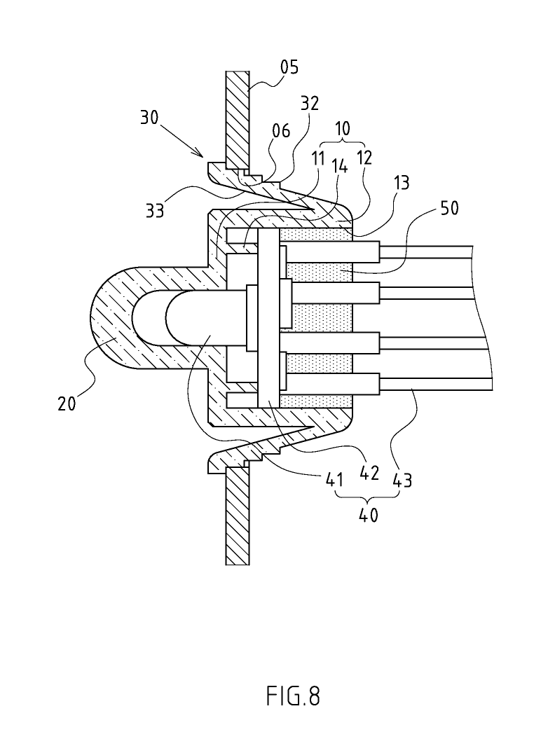

Referring also to FIG. 8, another preferred embodiment of said embedded positioning portion is shown wherein the embedded positioning portion 30 is formed externally onto the circumferential flange 12 of the LED baseplate retaining shell 10, and is composed of a plurality of oblique elastic sheets 33 with latching portion 32. The elastic sheets 33 can be embedded securely into the hole 06 of existing shell plate 05.

I claim:

1. An LED water-proofing diffuser embedded into the shell plate, of which said LED water-proofing diffuser comprises:
an LED baseplate retaining shell, which is a 3D holding space formed by an end wall and a circumferential flange; and an LED assembly port is formed at the other end of the circumferential flange;
an LED diffusing portion, which is of a hollow shape protruding from the end wall of the LED baseplate retaining shell; and the LED diffusing portion is available with light transmittance;
an embedded positioning portion, integrally formed onto the exterior of the end wall or circumferential flange of the LED baseplate retaining shell; said embedded positioning portion can be embedded securely into the hole of existing shell plate.

2. The structure defined in claim 1, wherein said LED diffusing portion is protruded from the center of the end wall of the LED baseplate retaining shell.

3. The structure defined in claim 1, wherein the embedded positioning portion comprises of several hooks arranged at interval.

4. The structure defined in claim 1, wherein the embedded positioning portion is composed of a plurality of oblique elastic sheets with latching portion.

5. The structure defined in claim 1, wherein said protruding rib flange is formed internally onto the end wall of the LED baseplate retaining shell.

6. The structure defined in claim 1, wherein the LED water-proofing diffuser is assembled externally onto an LED unit, which comprises at least an LED module, an LED substrate and electrical wire; the LED baseplate retaining shell of LED water-proofing diffuser A is used for accommodating the LED substrate of LED unit, and the LED diffusing portion used for accommodating the LED module of LED unit; moreover, waterproof agent is poured into the LED baseplate retaining shell to seal the LED substrate.

7. The structure defined in claim 1, wherein said LED water-proofing diffuser is applied to a traffic marking panel; the traffic marking panel comprises of a main body and an LED unit set on the marking surface of the main body; said LED water-proofing diffuser is assembled externally onto said LED unit; the main body of the traffic marking panel is provided with a hole for assembly of the LED unit; the LED unit comprises at least: an LED module, an LED substrate and electrical wire; the LED baseplate retaining shell of LED water-proofing diffuser is used for accommodating the LED substrate of LED unit, and the LED diffusing portion used for accommodating the LED module of LED unit; moreover, waterproof agent is poured into the LED baseplate retaining shell to seal the LED substrate.

8. The structure defined in claim 1, wherein said LED water-proofing diffuser is applied to an advertisement; the advertisement comprises of a main body and an LED unit set on the advertisement surface of the main body; the LED water-proofing diffuser is assembled externally onto said LED unit; the main body of advertisement is provided with a hole for assembly of the LED unit; the LED unit comprises at least: an LED module, an LED substrate and electrical wire; the LED baseplate retaining shell of LED water-proofing diffuser is used for accommodating the LED substrate of LED unit, and the LED diffusing portion used for accommodating the LED module of LED unit; moreover, waterproof agent is poured into the LED baseplate retaining shell to seal the LED substrate.

9. The structure defined in claim 1, wherein said LED water-proofing diffuser is applied to an ornament; the ornament comprises of a main body and an LED unit set on the platy surface of the main body; the LED water-proofing diffuser is assembled externally onto said LED unit; the platy surface on the main body of ornament is provided with a hole for assembly of the LED unit; said LED unit comprises at least: an LED module, an LED substrate and electrical wire; the LED baseplate retaining shell of LED water-proofing diffuser is used for accommodating the LED substrate of LED unit, and the LED diffusing portion used for accommodating the LED module of LED unit; moreover, waterproof agent is poured into the LED baseplate retaining shell to seal the LED substrate.
